(19) United States
(12) Patent Application Publication
(10) Pub. No.: US 2019/0048533 A1
(43) Pub. Date: Feb. 14, 2019

(54) Heated Covering Mat

(71) Applicant: Dwayne Anthony, Neptune, NJ (US)

(72) Inventor: Dwayne Anthony, Neptune, NJ (US)

(21) Appl. No.: 15/892,335

(22) Filed: Feb. 8, 2018

Related U.S. Application Data
(60) Provisional application No. 62/456,687, filed on Feb. 9, 2017.

(51) Int. Cl. E01C 11/24; H05B 3/34

(52) U.S. Cl. CPC E01C 11/245; H05B 3/34

(57) ABSTRACT

Heated mat for covering private driveways and public walkways for evaporating snow and ice accumulation in pedestrian areas.

### CLAIM OF PRIORITY

This patent application claims priority under 35 USC 119 (e) (1) from U.S. Provisional Patent Application Ser. No. 62/456,687 filed Feb. 9, 2017, of common inventorship herewith entitled, “Heated Mat,” which is incorporated herein by reference as though the same were set forth in its entirety.

### FIELD OF THE INVENTION

The present invention pertains to the field of heated mats, and more specifically to the field of heated mats for covering private driveways and public walkways for eliminating snow and ice accumulation in pedestrian areas.

### BACKGROUND OF THE INVENTION

During the winter months, many people can be found outside their home or apartment laboriously wielding a snow shovel to remove snow from their driveways and walkways. Sometimes the city sends a truck to shovel the streets and drop salt on icy areas but this does not, however, solve the problem of getting from one's front door to the shoveled streets. The task of removing accumulated snow from driveways, walkways, sidewalks and outdoor stairways must be accomplished by hard, manual labor, using a snow shovel to scoop up, lift, and heave the snow to the sides. In addition to shoveling snow, retail businesses face the added task of shoveling sand or snow on storefront sidewalks to afford traction for pedestrians and customers to safeguard against individuals slipping and possibly being injured. These types of shoveling tasks are physically demanding, so much so that people over the age of fifty are cautioned not to perform this laborious job as it could be dangerous, especially for those who are not physically fit.

The prior art has put forth several designs for a mat. Among these are:

US Patent Application No. 2007/0131666 to Mariah Gregg et al provides a heated mat having a heater carried by a mat construction. The mat construction includes a mat layer with drainage openings positioned at a non-peripheral region of the mat layer to allow melted ice to flow through from the top side to the bottom side of the mat layer. A drainage space is positioned beneath the mat to allow water to flow underneath and away from the mat construction.

U.S. Pat. No. 2,844,696 to Byron K. Custer, Jr. provides a snow melting mat adapted to be used on steps, entrances to buildings, on walks or the like so as to remove snow and ice from these places by melting thereby reducing the possibilities of accidents occurring.

U.S. Pat. No. 3,806,702 to D. Spencer provides a weatherproof electrically insulative mat having an electrical heat producing conductor therein and adapted for placement on an exterior surface to prevent accumulation of snow on such surface. A control system for supplying current to the conductor including a precipitation sensor, a temperature sensor and a control unit responsive to the sensors so that power is supplied to the conductor in the mat only when there is precipitation and the temperature is below 35 degrees. An improved mat structure that is approximately symmetrical of the central plane thereof so that when one side of the mat wears the mat can be reversed.

None of these prior art references describe the present invention.

### SUMMARY OF THE INVENTION

It is an object of the present invention to provide heated mats for covering private driveways and public walkways for evaporating snow and ice accumulation in pedestrian areas.

### BRIEF DESCRIPTION OF THE DRAWINGS

FIG. 1 is a top cutaway perspective view illustrating the wire inside the heated covering mat, constructed in accordance with the present invention.

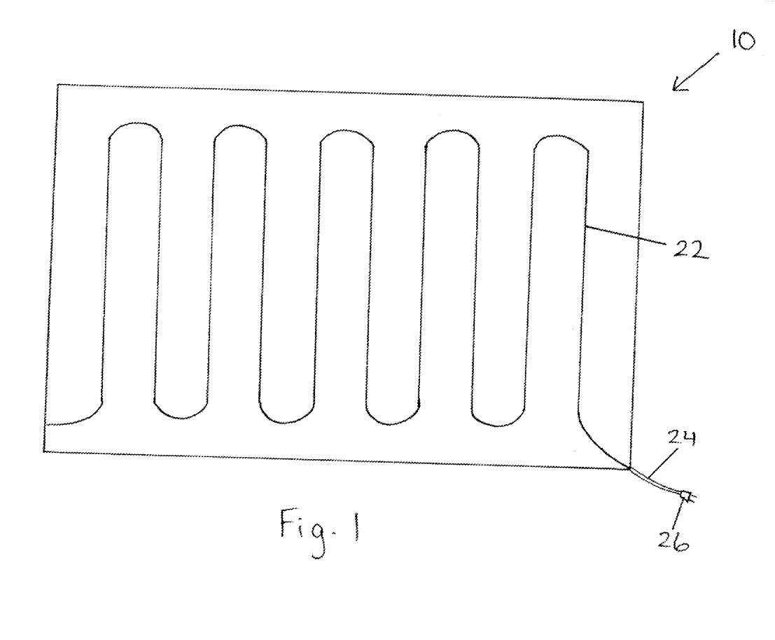

FIG. 2 is a bottom perspective view illustrating the heated mat, constructed in accordance with the present invention.

### DETAILED DESCRIPTION OF THE INVENTION

The present invention is a Heated Covering Mat providing a heated covering that is specially designed for private driveways and public walkways for evaporating snow and ice accumulation in pedestrian areas. Please refer to the drawings. Basically rectangular in shape to resemble a mat, as the name implies, the Heated Covering Mat is offered in a variety of dimensions to accommodate both household and commercial needs, with a standard covering mat measuring approximately ten to twenty feet (10′-20′) in length and approximately four to five feet (4′-5′) in width. The heated covering mat can be produced from slip-resistant, weather- and waterproof rubber, plastic, or comparable synthetic material.

The Heated Covering Mat 10 of the present invention comprises a top surface, a bottom surface an outer perimeter edge and a heating element 22 contained between the top surface and the bottom surface. The Heated Covering Mat 10 features an internally contained, insulated heating element. To heat the entire surface of the Heated Mat, the heating element is configured as a wire heating element 22 embedded in a serpentine pattern, sandwiched between two layers of the mat.

The top layer of the heated covering mat is constructed of material suitable for withstanding foot traffic comprising a slip resistant and weather resistant surface including rubber, plastic or silicon material having a textured surface, or not having a textured surface. The top surface of the heated covering mat is configured to ensure steady and stable footing when walking upon the mat.

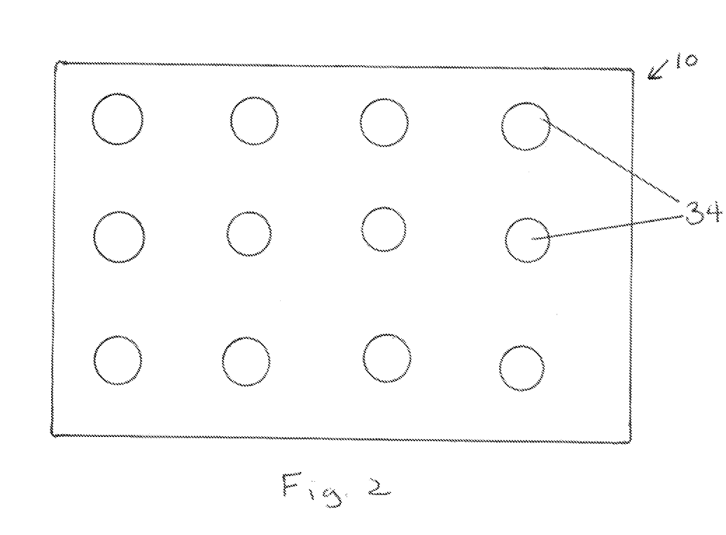

In an embodiment, the bottom layer, shown in FIG. 2, the heated covering mat comprises a multiplicity of suction cups 34 to aid the adhesion of the mat to the surface on which it is placed.

Similar in function to electric blanket, the wire 22 runs in a serpentine configuration which traverses the length and width of the mat, thus heating the entire area of the mat. Once activated, the temperature of the insulated heating element quickly rises, thus warming the surface of the mat to efficiently melt and evaporate any ice or snow. The Heated Covering Mat operates on conventional 110 volts, 60 hertz power to be connected to any outdoor power outlet by means of power cord 24 and plug 26.

The operation of the Heated Covering Mat is very simple and straightforward. When snow or ice is imminent, a desired area is covered with the appropriate Heated Covering Mat. By way of example, several units can be used to line a driveway. Similarly, an elongated mat can be draped over the exterior stairs leading to and from a doorway. When the Heated Covering Mat is in use, the highly resistive wire material converts electrical energy (current) into thermal energy (heat) which dissipates throughout the Heated Covering Mat, keeping the outer surface area warm and thus able to melt and evaporate away the precipitation. As mentioned above, the Heated Covering Mat is able to quickly evaporate any water residue, leaving behind a dry, clean surface that is safe for walking. After use, the Heated Covering Mat is removed from the designated surface, roiled into a tight coil and conveniently stored away until again needed.

There are several significant benefits and advantages associated with the Heated Covering Mat. Foremost, the Heated Covering Mat offers users an effective means of eliminating ice and snow from driveways and walkways. Incorporating a handy wire heating element into a practical covering, the Heated Covering Mat eliminates the need to spend precious minutes and hours laboriously scooping away snow. In this manner, the Heated Covering Mat eradicates one of the most difficult and arduous tasks faced by people who live in snow-prone areas. Comprising an upper surface having a textured or ridged, grooved surface ensuring steady footing while easily allowing melted ice and snow to evaporate or run off the surface of the mat, the Heated Covering Mat enables users to traverse their driveway, walkway, or steps quickly and safely. Simple in application, the Heated Covering Mat is particularly ideal on early morning when one may be running late for work. With the Heated Covering Mat covering their entranceway, working men and women are able get out on the road in a quick and expedient manner. Moreover, senior citizens and individuals who suffer from limited physical capabilities and health issues will not have to risk injury trying to shovel away snow. In addition, retail establishments can employ this practical tool to prevent the accumulation of snow, ice, and salt, making the sidewalks in front of their stores safer for their customers and passersby. The universal Heated Covering Mat can also be employed to remove winter residue from the surfaces of vehicles, providing a much needed solution to the challenges faced by those who do not have a garage or similar shelter in which to protect the automobiles from snow and ice. Manufactured of durable, high quality materials and components, the Heated Covering Mat will withstand many winters of continued use.

The Heated Covering Mat readily alleviates the daunting chore of snow shoveling. A heated driveway and walkway covering, the Heated Covering Mat proves invaluable on fast-paced winter mornings.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A heated mat for private driveways and public walkways for evaporating snow and ice in pedestrian areas comprising:
a top surface, a bottom surface, an outer perimeter edge and a heating element contained between the top surface and the bottom surface, and a power cord and plug.

2. The heated mat of claim 1 wherein the heating element is configured as a wire heating element embedded in a serpentine pattern, wherein the wire is sandwiched between the top surface and the bottom surface of the mat.

3. The heated mat of claim 1, wherein the top surface of the heated covering mat is constructed of material suitable for withstanding foot traffic comprising a slip resistant and weather resistant surface including rubber, plastic or silicon material having a textured surface.

4. The heated mat of claim 2, wherein the top surface of the heated covering mat is constructed of material suitable for withstanding foot traffic comprising a slip resistant and weather resistant surface including rubber, plastic or silicon material not having a textured surface.

5. The heated mat of claim 1 wherein the bottom surface of the heated covering mat comprises a multiplicity of suction cups to aid the adhesion of the mat to the surface on which it is placed.

6. The heated mat of claim 2 wherein the bottom surface of the heated covering mat comprises a multiplicity of suction cups to aid the adhesion of the mat to the surface on which it is placed.

7. The heated mat of claim 3 wherein the bottom surface of the heated covering mat comprises a multiplicity of suction cups to aid the adhesion of the mat to the surface on which it is placed.
